(19) United States
(12) Patent Application Publication
(10) Pub. No.: US 2015/0007992 A1
(43) Pub. Date: Jan. 8, 2015

(54) USE OF TERPOLYMERS AS FLUID LOSS ADDITIVES IN WELL CEMENTING

(71) Applicant: BASF SE, Ludwigshafen (DE)

(72) Inventors: Roland Reichenbach-Klinke, Traunstein (DE); Markus Wohlfahrt, Trostberg (DE)

(21) Appl. No.: 14/378,277

(22) PCT Filed: Jan. 9, 2013
(86) PCT No.: PCT/EP2013/050275

§ 371 Date: Aug. 12, 2014

(30) Foreign Application Priority Data
Feb. 13, 2012 (EP) 12155128.7

(51) Int. Cl. C09K 8/42; E21B 33/13

(52) U.S. Cl. CPC C09K 8/42; E21B 33/13
USPC 166/293; 166/292

(57) ABSTRACT

What is proposed is the use of a terpolymer comprising 5-95 mol % of 2-acrylamido-2-methylpropanesulfonic acid, 5-95 mol % of N,N-dimethylacrylamide and 5-12 mol % of acrylic acid as a fluid loss additive in well cementing.

The present invention relates to the use of terpolymers of 2-acrylamido-2-methylpropanesulfonic acid, acrylic acid and N,N-dimethylacrylamide as fluid loss additives in well cementings.

In the construction chemical sector, various copolymers are frequently used as water retention aids, which are also referred to as “fluid loss additives”. A specific field of use in this context is the cementing of wells in the development, exploitation and completion of underground mineral oil and natural gas deposits, and in deep wells.

Water retention aids or fluid loss additives have the task of reducing the release of water from a cement slurry. This is of significance especially in the field of mineral oil and natural gas exploration, since cement slurries consisting essentially of cement and water, in the course of cementing of the wells, are pumped through the ring space between the casing and the well wall. In the course of this, amounts of water can be released from the cement slurry to the underground formation. This is the case especially when the cement slurry flows past porous rock strata in the course of well cementing. The alkalized water originating from the cement slurry can then cause clays in the formations to swell and, with carbon dioxide from the natural gas or mineral oil, form calcium carbonate deposits. These effects reduce the permeability of the deposits, and the production rates are also adversely affected as a result.

Moreover, the cement slurries, as a result of the release of water to the porous underground formations, no longer solidify homogeneously and as a result become pervious to gases and to liquid hydrocarbons and water. This can subsequently lead to escape of the fossil energy carriers through the ring space filled with porous cement.

There have therefore been efforts over a prolonged period to lower such water losses from the cement slurries used to a tolerable minimum.

EP 0 116 671 A1 describes, for example, a cement slurry for deep wells, wherein the content of copolymers is said to reduce water loss. An important constituent of the copolymers used is formed by acrylamides, and especially 2-acrylamido-2-methylpropanesulfonic acid (AMPS®). According to this document, the cement slurries should contain between 0.1 and 3% by weight of the suitable copolymers.

Well cementing and a composition suitable therefor are also addressed by EP 1 375 818 A1. In this case, for fluid loss control, a polymer additive is used which comprises, as well as AMPS®, additional maleic acid, N-vinylcaprolactam and 4-hydroxybutyl vinyl ether.

Likewise based on AMPS® and partially hydrolyzed acrylamide is a copolymer according to U.S. Pat. No. 4,015,991. The copolymer described in this patent is likewise said to improve the water retention capacity in cementitious compositions. The primary field of use mentioned is the cementing of wells.

The use of copolymers of 2-acrylamido-2-methylpropanesulfonic acid and N,N-dimethylacrylamide (DMAA) as a fluid loss additive in well cementing is also described in U.S. Pat. No. 4,515,635. Similar polymers can also be found in U.S. Pat. No. 4,555,269.

The water-soluble copolymers according to U.S. Pat. No. 6,395,853 B1 comprise, inter alia, acrylamides and AMPS®. At the forefront of this property right is a process for reducing water loss in a slurry which is used to obtain mineral oil. In this context, particular mention is made of well cementing and completion, and of the well slurry preceding these process steps.

At the center of U.S. Pat. No. 4,700,780 is a process for reducing water loss in cementitious compositions which also comprise defined salt concentrations. The water retention aid is again a polymer, or polymer salt of AMPS®, and in this case the units of styrene and acrylic acid must also be present.

Terpolymers of 2-acrylamido-2-methylpropanesulfonic acid, acrylic acid and N,N-dimethylacrylamide also form part of the prior art. For instance, U.S. Pat. No. 4,554,081 discusses these terpolymers, preferably in a composition of 16.8 mol % of AMPS®, 73.2 mol % of DMAA and 10 mol % of acrylic acid, and the use thereof as a fluid loss additive in completion fluids, drilling muds and workover fluids with high densities in the field of oil and gas production.

In addition, Plank et al. (J. Appl. Polym. Sci. 106, 3889-3894, 2007—DOI: 10.1002/app.26897) describe such terpolymers with low proportions of acrylic acid (approx. 1% by weight or approx. 3.6 mol %). In this publication, the efficacy of a copolymer of AMPS® and DMAA as a fluid loss additive in well cementing is compared with said terpolymer. It was found that the efficacy of the copolymer is no different from that of the terpolymer with low proportions of acrylic acid.

These known co- and terpolymers each have a different profile of properties with specific advantages and disadvantages. A general weakness intrinsic to most of these ionic polymers is that their water retention action declines in the presence of high salt concentrations as typically occur in seawater, which is frequently used to make up the cement slurries in offshore oil and gas wells. This is also true especially of salts of divalent cations such as Mg²⁺ and Ca²⁺.

Over a long period, there have therefore been concerted attempts to provide novel molecules or polymers whose water retention capacity is stable, especially at high salt concentrations, especially in the field of oil and gas exploration and in deep wells.

This object is achieved by the features of the independent claims. The dependent claims relate to preferred embodiments.

It has been found, surprisingly, that terpolymers of 2-acrylamido-2-methylpropanesulfonic acid, N,N-dimethylacrylamide and acrylic acid with an acrylic acid content of about 5 to 12 mol % have distinct advantages with regard to efficacy as a fluid loss additive in well cementing.

The present invention provides for the use of a terpolymer comprising 5-95 mol % of 2-acrylamido-2-methylpropanesulfonic acid, 5-95 mol % of N,N-dimethylacrylamide and 5-12 mol % of acrylic acid as a fluid loss additive in well cementing.

The terpolymer preferably comprises 8-12 mol % and more preferably 10 to 11 mol % of acrylic acid.

Although the molar ratio of 2-acrylamido-2-methylpropanesulfonic acid to N,N-dimethylacrylamide is not particularly critical, it is preferred in the context of the present invention that the molar ratio of 2-acrylamido-2-methylpropanesulfonic acid to N,N-dimethylacrylamide is between 50:50 and 80:20, especially between 60:40 and 70:30.

The inventive terpolymer can appropriately be prepared by means of free-radical copolymerization of the abovementioned comonomers. Due to the ionic or hydrophilic character of the comonomers, the copolymerization can appropriately be effected in aqueous solution. It is possible that the 2-acrylamido-2-methylpropanesulfonic acid and the acrylic acid are present fully or partly in the form of salts of alkali metals, alkaline earth metals or mixtures thereof, especially in the form of Na, K, Mg and/or Ca salts. These salts can be used directly for copolymerization. It is likewise possible that these salts are formed only in a subsequent neutralization of the terpolymers formed. Both routes for introduction of said salts into the terpolymer can be taken independently of one another or in combination with one another.

The inventive terpolymer preferably has a molecular weight in the range from 500,000 to 4,000,000 and especially from 1,000,000 to 2,000,000 g/mol.

In the field of mineral oil and natural gas exploration, and in deep wells, as already mentioned at the outset, cement slurries consisting essentially of cement and water, for cementing of the wells, are pumped through the ring space between the casing and the well wall. It is still customary nowadays to use portland cements for this purpose. Accordingly, the inventive use is preferably characterized in that the terpolymer is used as a fluid loss additive in a cement slurry comprising portland cement.

Due to the high salt tolerance of the inventive terpolymers, these terpolymers can advantageously be used as fluid loss additives in cement slurries which comprise seawater or have been made up with seawater.

In the field of mineral oil production, the use of what are called weighting fluids is customary, these generally consisting of concentrated aqueous salt solutions of alkali metal and/or alkaline earth metals. In the course of well cementing, there may therefore be at least partial mixing of weighting fluids and cement slurries. Due to the high salt tolerance of the inventive terpolymers, the action thereof is not lost even in such cement slurries.

In summary, it can be stated that the inventive terpolymer is appropriately and advantageously used as a fluid loss additive in the cementing of wells in the development, exploitation and completion of underground mineral oil and natural gas deposits, and in deep wells, and is notable especially for tolerance to high salt concentrations which is surprising in view of the prior art.

The present invention is now illustrated in detail by the examples which follow.

### EXAMPLE 1

A glass reactor with steel stirrer was initially charged with 2200 g of tap water and 158 g of 20% NaOH whilst stirring. Subsequently, 135 g of AMPS® were added while cooling, such that the temperature did not exceed 30° C. Thereafter, 95 g of DMAA and 13.5 g of acrylic acid (which corresponds to approx. 10.6 mol %) were mixed in, and washed in with 100 ml of tap water. In the next step, the pH was adjusted to 7.6 with the aid of NaOH or AMPS®. Within one hour, the reaction mixture was then heated to 62° C. under a nitrogen blanket. On attainment of constant temperature, the polymerization was initiated by adding 0.65 g of tetraethylenepentamine (TEPA) and 5 g of Na₂S₂O₈, dissolved in approx. 10 ml of H₂O. An exothermic reaction was observed, in the course of which the temperature rose to 70-74° C. After the reaction had started, the mixture was stirred for one hour without any further external heating. The end product was a pale yellowish, viscous solution with a pH of 7-7.5, a solids content of 10-12% by weight and a Brookfield viscosity of 6000 mPa*s.

### EXAMPLE 2

The liquid loss (“LL”) and the rheology of the terpolymer from example 1 were determined in comparison with a commercially available AMPS®/DMAA copolymer (Polytrol® FL 34 from BASF Construction Polymers GmbH) according to :API Recommended Practice 10 B at 190° F. (88° C.) in the following cement slurries with or without addition of salt:

800 g of class G cement (from Dyckerhoff)

352 g of water

0.6% bwoc of fluid loss additive

1.0 g of antifoam (triisobutylphosphate)

The results are reproduced in tables 1 and 2, table 1 relating to Polytrol® FL 34 and table 2 to the terpolymer from example 1. The amount of salt is reported in grams and percent by weight (based on the water content): “bwoc” means percent by weight of cement.

TABLE 1
(Polytrol ® FL 34):

| | | | | | | | | | | | Blows out |
|---|---|---|---|---|---|---|---|---|---|---|---|
| Sea Salt | | NaCl | | Fann 35 - rheology [lbf/100 sqft] | | | | | | LL | after: |
| [g] | [%] | [g] | [%] | 300 | 200 | 100 | 6 | 3 | 600 | [ml] | [min:sec] |
| — | — | — | — | 184 | 138 | 84 | 10 | 8 | 288 | 66 | |
| — | — | 77.3 | 18.0 | 122 | 90 | 57 | 19 | 18 | 175 | 509 | 06:27 |
| 14.7 | 4.0 | — | — | 148 | 115 | 76 | 28 | 24 | 222 | 138 | |
| — | — | 39.1 | 10.0 | 156 | 122 | 82 | 31 | 28 | 232 | 282 | 21:26 |

TABLE 2
(terpolymer):

| Sea Salt | | NaCl | | Fann 35 - rheology [lbf/100 sqft] | | | | | | LL |
|---|---|---|---|---|---|---|---|---|---|---|
| [g] | [%] | [g] | [%] | 300 | 200 | 100 | 6 | 3 | 600 | [ml] |
| — | — | — | — | 258 | 200 | 130 | 30 | 24 | >300 | 20 |
| — | — | 77.3 | 18.0 | 114 | 80 | 47 | 6 | 4 | 170 | 156 |
| 14.7 | 4.0 | — | — | >300 | 228 | 153 | 39 | 36 | >300 | 42 |
| — | — | 39.1 | 10.0 | 142 | 165 | 64 | 10 | 8 | 212 | 28 |

It is clearly evident that the terpolymer according to example 1 with the same dosage enables much lower liquid losses than the commercially available Polytrol® FL 34. In addition, the terpolymer according to example 1 is much more salt-tolerant than Polytrol® FL 34, even towards sea salt.

This result is also surprising in that it is stated in the prior art (Plank et al J. Appl. Polym. Sci. 106, 3889-3894, 2007) that an <addition of acrylic acid has no influence on the efficacy of AMPS/DMAA copolymers as a fluid loss additive. It is apparent here that the exact proportion of acrylic acid is crucial.

In addition, it was found that the terpolymer according to example 1, compared to Polytrol® FL 34, exerts only an insignificant retarding effect, if any, on the stiffening time of the cement slurries.

1-8. (canceled)

9. A method of preventing fluid loss during well cementing comprising:
adding to a slurry comprising a cement and a terpolymer; and
cementing a well,
wherein the terpolymer comprises:
from 5-95 mol % of 2-acrylamido-2-methylpropanesulfonic acid;
from 5-95 mol % of N,N-dimethylacrylamide; and
5-12 mol % of acrylic acid.

10. The method according to claim 9, wherein the terpolymer comprises 8-12 mol % of acrylic acid.

11. The method according to claim 9, wherein the molar ratio of 2-acrylamido-2-methylpropanesulfonic acid to N,N-dimethylacrylamide is between 50:50 and 80:20.

12. The method according to claim 10, wherein the molar ratio of 2-acrylamido-2-methylpropanesulfonic acid to N,N-dimethylacrylamide is between 50:50 and 80:20.

13. The method according claim 9, wherein the 2 acrylamido-2-methylpropanesulfonic acid and the acrylic acid are present fully or partly in the form of salts of at least one member selected from the group consisting of an alkali metal and an alkaline earth metal.

14. The method according claim 10, wherein the 2 acrylamido-2-methylpropanesulfonic acid and the acrylic acid are present fully or partly in the form of salts of at least one member selected from the group consisting of an alkali metal and an alkaline earth metal.

15. The method according claim 13, wherein the 2 acrylamido-2-methylpropanesulfonic acid and the acrylic acid are present fully or partly in the form of salts of at least one member selected from the group consisting of Na, K, Mg and Ca.

16. The method according claim 14, wherein the 2 acrylamido-2-methylpropanesulfonic acid and the acrylic acid are present fully or partly in the form of salts of at least one member selected from the group consisting of Na, K, Mg and Ca.

17. The method according to claim 9, wherein the terpolymer has a molecular weight in the range from 500,000 to 4,000,000 and especially 1,000,000 to 2,000,000 g/mol.

18. The method according to claim 9, wherein the terpolymer has a molecular weight in the range from 1,000,000 to 2,000,000 g/mol.

19. The method according to claim 9, wherein the cement is portland cement.

20. The method according to claim 9, wherein the terpolymer is used as a fluid loss additive in a cement slurry comprising seawater.

21. The method according to claim 9, wherein the well is a natural gas well, a mineral oil well or a deep well.

22. The method according to claim 9, wherein the terpolymer comprises 10 to 11 mol % of acrylic acid.

23. The method according to claim 9, wherein the molar ratio of 2-acrylamido-2-methylpropanesulfonic acid to N,N-dimethylacrylamide is between 60:40 and 70:30.

24. The method according to claim 10, wherein the molar ratio of 2-acrylamido-2-methylpropanesulfonic acid to N,N-dimethylacrylamide is between 60:40 and 70:30.

25. The method according claim 11, wherein the 2 acrylamido-2-methylpropanesulfonic acid and the acrylic acid are present fully or partly in the form of salts of at least one member selected from the group consisting of an alkali metal and an alkaline earth metal.

26. The method according claim 12, wherein the 2 acrylamido-2-methylpropanesulfonic acid and the acrylic acid are present fully or partly in the form of salts of at least one member selected from the group consisting of Na, K, Mg and Ca.

27. The method according to claim 10, wherein the terpolymer has a molecular weight in the range from 1,000,000 to 2,000,000 g/mol.

28. The method according to claim 10, wherein the cement is portland cement.
